(19) United States
(12) Patent Application Publication
(10) Pub. No.: US 2006/0001846 A1
(43) Pub. Date: Jan. 5, 2006

(54) Exposure system and method for manufacturing semiconductor device

(76) Inventors: Takuya Kono, Yokohama-shi (JP); Tatsuhiko Higashiki, Fujisawa-shi (JP); Takashi Sato, Fujisawa-shi (JP); Shoji Mimotogi, Yokohama-shi (JP); Soichi Inoue, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/170,165

(22) Filed: Jun. 30, 2005

(30) Foreign Application Priority Data
Jul. 5, 2004 (JP) P2004-198409

(51) Int. Cl. G03B 27/00

(52) U.S. Cl. 355/18

(57) ABSTRACT

An exposure system includes a simulator speculating first and second calculated doses to project first and second reference marks onto first and second resist films, respectively, an exposure tool projecting the first reference mark onto the first resist film at test doses to form test resist patterns, a choose module choosing an optimum pattern among the test resist patterns and choosing a first optimum dose used for the optimum pattern, and a dose calculator calculating a second optimum dose for the second reference mark by correcting the first optimum dose based on the first and the second calculated doses.

### CROSS REFERENCE TO RELATED APPLICATIONS AND INCORPORATION BY REFERENCE

This application is based upon and claims the benefit of priority from prior Japanese Patent Application P2004-198409 filed on Jul. 5, 2004; the entire contents of which are incorporated by reference herein.

### BACKGROUND OF THE INVENTION

1. Field of the Invention

The present invention relates to photolithographic projection and in particular to an exposure system and a method for manufacturing a semiconductor device.

2. Description of the Related Art

In a semiconductor device manufacturing process, accuracy of a lithography process is a crucial factor for reducing a size of the semiconductor device. In a case where a mask pattern is projected onto a resist, optimizing focus offset and dose condition for each photo mask is necessary to improve a reliability of the semiconductor device. Meanwhile, minor changes to an integrated circuit of the semiconductor device such as the SRAM and the DRAM are successively made. Accordingly, the semiconductor device usually has sister products. Such sister products belong to same product category and are designed in compliance with same design rule. When the minor changes to the integrated circuit are made, new photo mask is manufactured. Though such sister products are equivalent in the product category and the design rule, it is necessary to optimize the exposure conditions such as the focus offset and the dose condition again for the new photo mask. In the meantime, if the photo mask is damaged, the damaged photo mask should be replaced with new photo mask belonging to same lot. In this case, it is also necessary to optimize the exposure conditions for the new photo mask, since the manufacturing error may occur and the new photo mask may have different transparency from the damaged photo mask. Here, during the optimization of the exposure condition for the new photo mask, it is impossible to continue to manufacture the semiconductor device. Generally, the optimization of the exposure condition takes a long time since the exposure condition includes many combinations of parameters. In Japanese Patent Laid-Open Publication No. 2002-190443, a method for choosing optimized exposure tool from a plurality of exposure tools to improve a defect rate of the semiconductor device is proposed. However, a method for reducing a size change of the projected mask pattern caused by replacement of the photo mask has not been proposed.

### SUMMARY OF THE INVENTION

An aspect of present invention inheres in an exposure system according to an embodiment of the present invention. The exposure system has a simulator configured to speculate a first calculated dose required to project a first reference mark of a first mask onto a first resist film based on a first biased width and a second calculated dose required to project a second reference mark of a second mask onto a second resist film based on a second biased width, the first and the second masks being equivalent in a design rule, the first and the second reference marks having a same designed width, the first biased width being a sum of the designed width and a first bias, the second biased width being a sum of the designed width and a second bias, an exposure tool configured to project the first reference mark onto the first resist film at a plurality of test doses to form a plurality of test resist patterns in the first resist film, a choose module configured to choose an optimum resist pattern among the test resist patterns and to choose a first optimum dose used for forming the optimum resist pattern among the test doses, and a dose calculator configured to calculate a second optimum dose for the second mask by correcting the first optimum dose based on the first and the second calculated doses.

Another aspect of the present invention inheres in a method for manufacturing a semiconductor device according to the embodiment of the present invention. The method for manufacturing a semiconductor device includes preparing a first mask having a first reference mark and a second mask having a second reference mark, the first and the second masks being equivalent in a design rule, the first and the second reference marks having the same designed width, speculating a first calculated dose required to project the first reference mark onto a first resist film based on a first biased width that is a sum of the designed width and a first bias, speculating a second calculated dose required to project the second reference mark onto a second resist film based on a second biased width that is a sum of the designed width and a second bias, projecting the first reference mark onto the first resist film at a plurality of test doses to form a plurality of test resist patterns in the first resist film, choosing an optimum resist pattern among the test resist patterns, choosing a first optimum dose used for forming the optimum resist pattern among the test doses, calculating a second optimum dose by correcting the first optimum dose based on the first and the second calculated doses, and projecting a mask pattern of the second mask onto the second resist film coated on a silicon wafer at the second optimum dose to form a circuit pattern on the silicon wafer.

### BRIEF DESCRIPTION OF DRAWINGS

FIG. 1 is a diagram of an exposure system in accordance with a first embodiment of the present invention;

FIG. 2 is a plan view of a first mask in accordance with the first embodiment of the present invention;

FIG. 3 is an enlarged plan view of the first mask in accordance with the first embodiment of the present invention;

FIG. 4 illustrates an exposure tool in accordance with the first embodiment of the present invention;

FIG. 5 is a diagram of a database in accordance with the first embodiment of the present invention;

FIG. 6 is a sample graph showing a relationship between a dose and a reference width of a reference mark in accordance with the first embodiment of the present invention;

FIG. 7 is a flowchart depicting a method for manufacturing a semiconductor device in accordance with the first embodiment of the present invention;

FIG. 8 is a diagram of the exposure system in accordance with a first modification of the first embodiment of the present invention;

FIG. 9 is a plan view of the first mask in accordance with the first modification of the first embodiment of the present invention;

FIG. 10 is a flowchart depicting the method for manufacturing the semiconductor device in accordance with a second modification of the first embodiment of the present invention;

FIG. 11 is a diagram of the exposure system in accordance with the second embodiment of the present invention;

FIG. 12 is a flowchart depicting the method for manufacturing the semiconductor device in accordance with the second embodiment of the present invention;

FIG. 13 is a diagram of the exposure system in accordance with a third embodiment of the present invention;

FIG. 14 is a flowchart depicting the method for manufacturing the semiconductor device in accordance with the third embodiment of the present invention; and

FIG. 15 is a sample graph showing the relationship between the dose and the reference width of the reference mark in accordance with the third embodiment of the present invention.

### DETAILED DESCRIPTION OF THE INVENTION

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified.

### First Embodiment

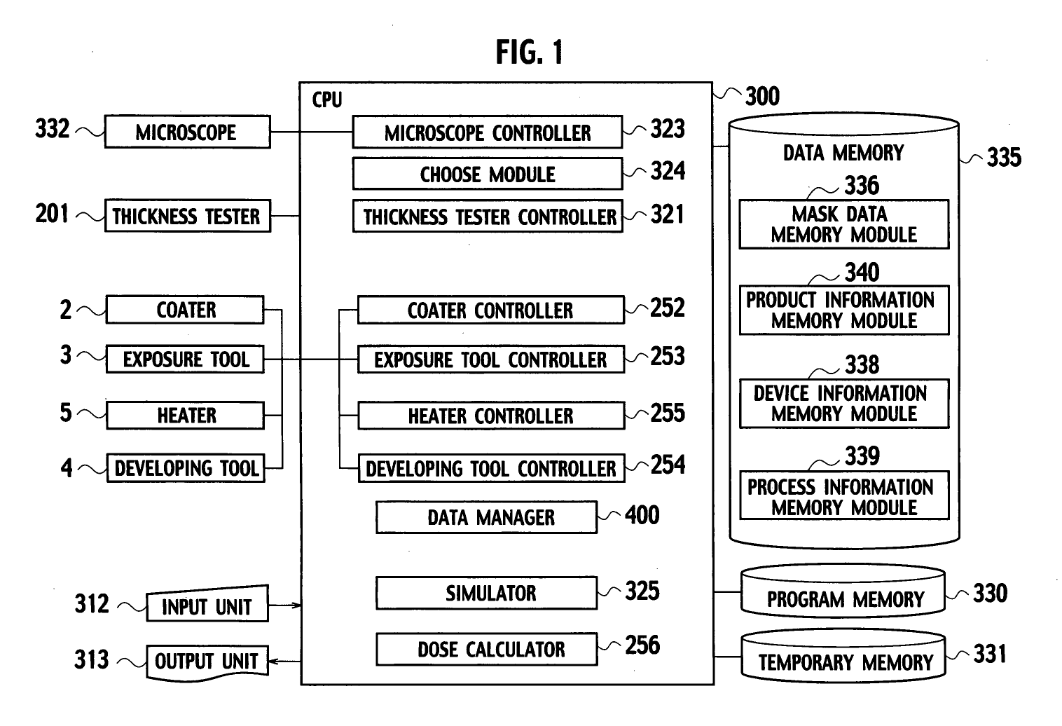

With reference to FIG. 1, an exposure system in accordance with a first embodiment includes a microscope 332, a central processing unit (CPU) 300, and an exposure tool 3. The CPU 300 includes a simulator 325, a choose module 324, and a dose calculator 256. The microscope 332 is configured to measure a first actual width of a first reference mark of a first mask and a second actual width of a second reference mark of a second mask. Here, the first and the second masks are used for manufacturing semiconductor devices belonging to same product category and designed in compliance with same design rule. Also, the first and the second reference marks have a same designed width. The simulator 325 is configured to speculate a first calculated dose required to project the first reference mark onto a first resist film based on the first actual width and a second calculated dose required to project the second reference mark onto a second resist film based on the second actual width. Here, chemically amplified resists can be used for the first and the second resist films. The exposure tool 3 is configured to project the first reference mark onto the first resist film at a plurality of test doses to form a plurality of test resist patterns in the first resist film. The choose module 324 is configured to choose an optimum resist pattern among the test resist patterns and to choose a first optimum dose used for forming the optimum resist pattern among the test doses. The dose calculator 256 is configured to calculate a second optimum dose for the second mask by correcting the first optimum dose based on the first and the second calculated doses. Further, the exposure system includes a coater 2, a heater 5, a developing tool 4, and a thickness tester 201.

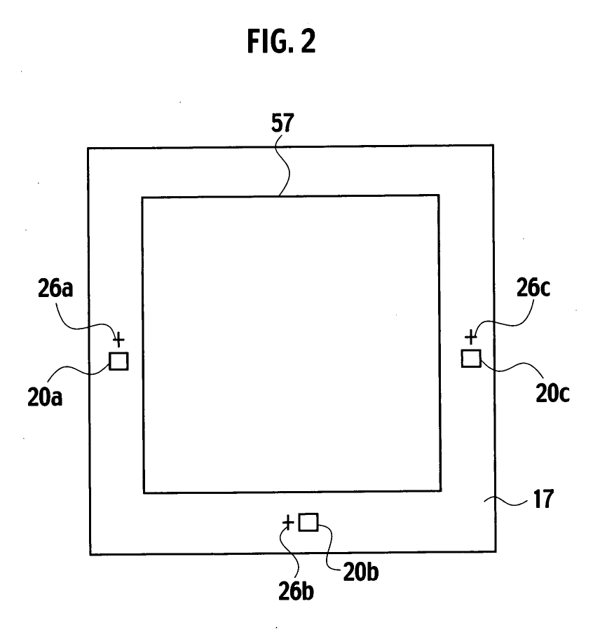

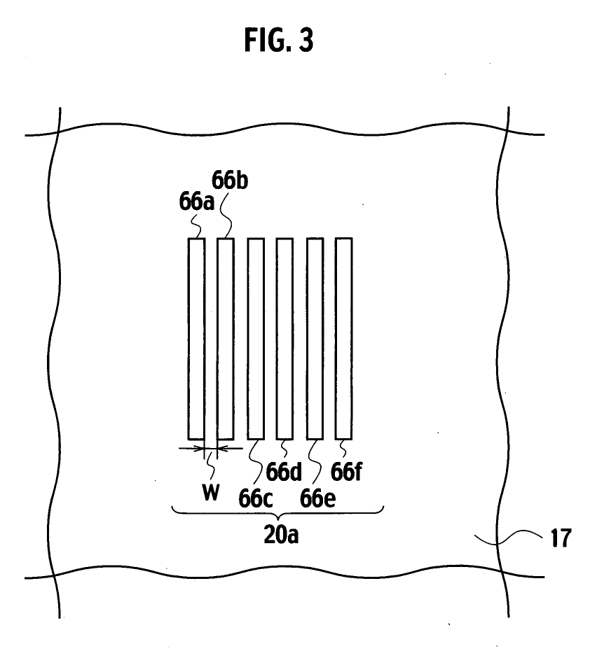

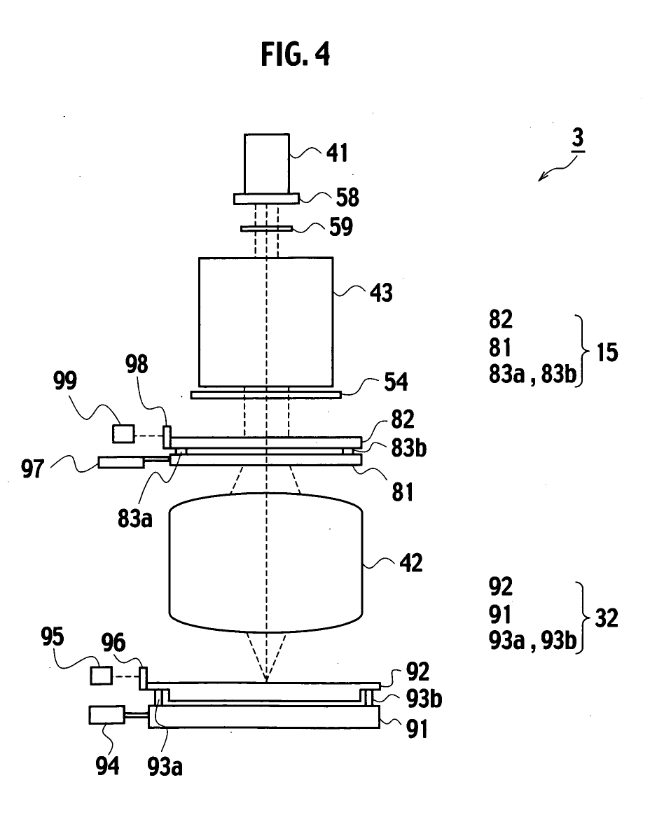

FIG. 2 shows the exampled first mask designed in compliance with the design rule of 150 nm. The first mask includes a device pattern window 57 surrounded by a light shielding film 17. The device pattern window 57 contains a circuit pattern of the SRAM to be manufactured, for example. A first reference mark 20a is delineated in the light shielding film 17. As shown in FIG. 3, the first reference mark 20a contains a plurality of transparent portions 66a, 66b, 66c, 66d, 66e, and 66f. The transparent portions 66a-66f are arranged at a reference width “W”. For example, the designed width of the reference width “W” is 600 nm. By measuring a first actual width “D_{A1}” of the reference width “W” in the first reference mark 20a, manufacturing error of the first mask can be quantified. First reference marks 20b and 20c shown in FIG. 2 also contain the plurality of transparent portions. Also, a plurality of alignment marks 26a, 26b, and 26c are delineated in the light shielding film 17. The alignment marks 26a-26c are used for the arrangement of the first mask on a reticle stage 15 in the exposure tool 3 shown in FIGS. 1 and 4.

The second mask and the first mask are identical in a design and belong to same lot. Or, the second mask is a sister product to the first mask and the first and the second masks belong to different lot. Such second mask is made in the case where a minor change to the SRAM is made. Therefore, the second mask contains a circuit pattern that is a modification of the circuit pattern delineated in the device pattern window 57 in the first mask shown in FIG. 2. The second mask also contains the second reference marks and the alignment marks. The second reference marks of the second mask are similar to the first reference marks 20a-20c of the first mask shown in FIGS. 2 and 3.

The microscope 332 shown in FIG. 1 measures the first actual width “D_{A1}” of the reference width “W” of the first mask shown in FIG. 3. Also, the microscope 332 measures the second actual width “D_{A2}” of the reference width “W” of the second mask. Further, the microscope 332 measures line widths of test resist patterns. The “test resist patterns” are formed by projecting the first reference mark 20a-20c of the first mask onto the first resist film at a plurality of test doses by the exposure tool 3 shown in FIG. 4. The atomic force microscope (AFM) and the scanning electron microscope (SEM) can be used for the microscope 332 shown in FIG. 1.

With reference next to FIG. 4, the exposure tool 3 includes a light source 41 emitting a light, an aperture diaphragm holder 58 disposed under the light source 41, a polarizer 59 polarizing the light emitted from the light source 41, an illuminator 43 condensing the light, a slit holder 54 disposed under the illuminator 43, a reticle stage 15 disposed beneath the slit holder 54, a projection optical system 42 disposed beneath the reticle stage 15, and a wafer stage 32 disposed beneath the projection optical system 42.

The reticle stage 15 includes a reticle XY stage 81, shafts 83a, 83b provided on the reticle XY stage 81, and a reticle tilting stage 82 attached to the reticle XY stage 81 through the shafts 83a, 83b. The reticle stage 15 is attached to a reticle stage aligner 97. The reticle stage aligner 97 aligns the position of the reticle XY stage 81. Each of the shafts 83a, 83b extends from the reticle XY stage 81. Therefore, the position of the reticle tilting stage 82 is determined by the reticle XY stage 81. The tilt angle of the reticle tilting stage 82 is determined by the shafts 83a, 83b. Further, a reticle stage mirror 98 is attached to the edge of the reticle tilting stage 82. The position of the reticle tilting stage 82 is monitored by an interferometer 99 disposed opposite the reticle stage mirror 98.

The wafer stage 32 includes a wafer XY stage 91, shafts 93a, 93b provided on the wafer XY stage 91, and a wafer tilting stage 92 attached to the wafer XY stage 91 through the shafts 93a, 93b. The wafer stage 32 is attached to a wafer stage aligner 94. The wafer stage aligner 94 aligns the position of the wafer XY stage 91. Each of the shafts 93a, 93b extends from the wafer XY stage 91. Therefore, the position of the wafer tilting stage 92 is determined by the wafer XY stage 91. The tilt angle of the wafer tilting stage 92 is determined by the shafts 93a, 93b. Further, a wafer stage mirror 96 is attached to the edge of the wafer tilting stage 92. The position of the wafer tilting stage 92 is monitored by an interferometer 95 disposed opposite the wafer stage mirror 96.

With reference again to FIG. 1, the coater 2 is configured to coat one silicon wafer with an antireflection coating and the first resist film. Also, the coater 2 is configured to coat another silicon wafer with the antireflection coating and the second resist film. Here, a lot number or an identifier is given to each of the silicon wafers, for example. The first resist film is to be exposed to the light through the first mask shown in FIG. 2. The second resist film is to be exposed to the light through the second mask. However, both compositions of the first and the second resist films are same. A spin coater can be used for the coater 2, for example. The silicon wafer coated with the first resist film or the second resist film is disposed on the wafer stage 32 in the exposure tool 3 shown in FIG. 4. The thickness tester 201 shown in FIG. 1 is configured to measure each thickness of the antireflection coating, the first resist film, and the second resist film. The spectroscope can be used for the thickness tester 201, for example.

The heater 5, such as an oven, is configured to bake the first resist film and the second resist film on the silicon wafers in order to perform a post exposure bake (PEB) process after the first and the second resist films are exposed to the light in the exposure tool 3. The oven that can control heating conditions including a baking time and an internal temperature can be used for the heater 5.

The developing tool 4 is configured to develop the first resist film and the second resist film coated on the silicon wafers. Developing conditions including the concentration of a developer, a developer temperature, and a developing time are controlled by the CPU 300.

Also, the CPU 300 further includes a microscope controller 323, a thickness tester controller 321, a coater controller 252, an exposure tool controller 253, a heater controller 255, a developing tool controller 254, and a data manager 400. Also, a data memory 335 is connected to the CPU 300. The data memory 335 includes a mask data memory module 336, a product information memory module 340, a device information memory module 338, and a process information memory module 339.

The product information memory module 340 stores a manufacturing recipe for the semiconductor device to be manufactured by the first mask shown in FIG. 2. The “manufacturing recipe” is a data file containing information on the silicon wafer, compositions of the antireflection coating, the first resist film, and the second resist film, coater conditions, the numerical aperture (NA), the coherence factor σ, and an aperture type for annular or quadrupolar illumination, the heating conditions in the PEB process, the composition of the developer solution used in the developing process, the concentration of the developer solution, and the developing time.

The device information memory module 338 stores instrumental error data of the coater 2, the exposure tool 3, the heater 5, and the developing tool 4. For example, the device information memory module 338 stores a difference between actual rotation speed and set rotation speed of the coater 2. Also, the device information memory module 338 stores dose error data of the light source 41 shown in FIG. 4, position error data and leveling error data of the reticle stage 15 and the wafer stage 32, accuracy data, birefringence data, and aberration data of a telecentric system of the projection optical system 42, and the unevenness data of the intensity of the light. Further, the device information memory module 338 stores thermometer error data in the heater 5 and the developing tool 4 shown in FIG. 1 and concentration meter error data in the developing tool 4.

The microscope controller 323 sets the scan rate, the resolution, and the magnification of the microscope 332. The microscope controller 323 transfers the first actual width “D_{A1}” and the second actual width “D_{A2}” measured by the microscope 332 to the mask data memory module 336. Also, the microscope controller 323 stores the information on the line widths of the test resist patterns measured by the microscope 332 in the process information memory module 339. Here, the data manager 400 receives the data of the identifier of the silicon wafer covered with the first resist film and the data of the identification name of the first mask from an input unit 312, for example. The data manager 400 associates the data of the line widths of the test resist patterns with the data of the identifier of the silicon wafer and the data of the identification name of the first mask in the process information memory module 339.

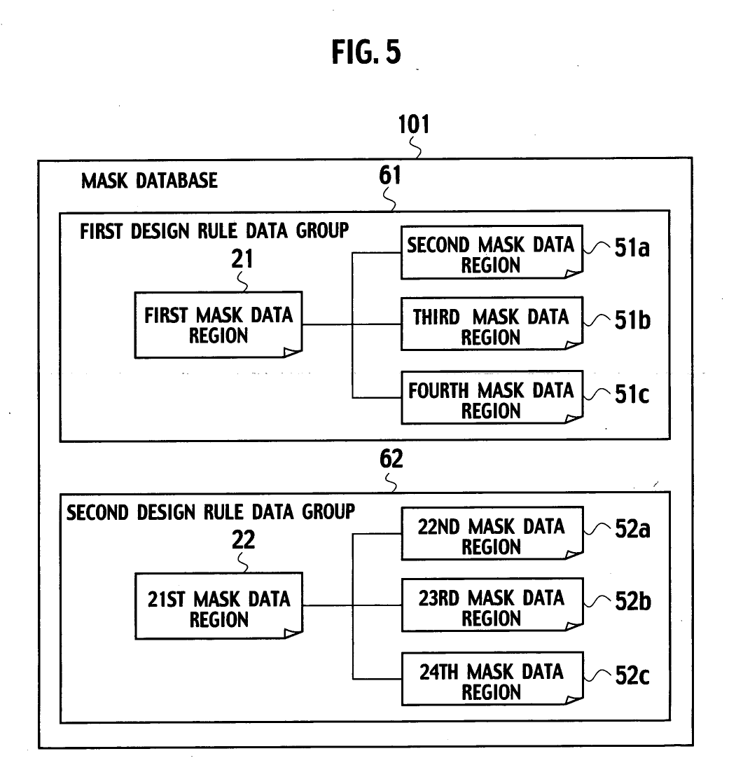

The choose module 324 shown in FIG. 1 chooses the first optimum dose “E₁” based on the line widths of the test resist patterns measured by the microscope 332. Specifically, the choose module 324 chooses the “optimum resist pattern” from the plurality of test resist patterns. Here, the “optimum resist pattern” has the line width that is nearest to a product design value stored in the product information memory module 340. The choose module 324 defines a dose used for forming the optimum resist pattern as the first optimum dose “E₁”. The choose module 324 stores the first optimum dose “E₁” in the first mask data region 21 shown in FIG. 5.

The simulator 325 shown in FIG. 1 speculates the first calculated dose “V₁” required to form a resist pattern having a line width that is equal to the product design value in the case where the first reference pattern 20a of the first mask is projected onto the first resist film. Here, the simulator 325 speculates the first calculated dose “V₁” based on the first actual width “D_{A1}” of the first reference pattern 20a. Also, the simulator 325 shown in FIG. 1 speculates the second calculated dose “V₂” required to form the resist pattern having the line width that is equal to the product design value in the case where the second reference pattern of the second mask is projected onto the second resist film. Here, the simulator 325 speculates the second calculated dose “V₂” based on the second actual width “D_{A2}” of the second reference pattern. The simulator 325 speculates the first calculated dose “V₁” and the second calculated dose “V₂” by calculating light intensities of projected images of the first and the second reference patterns. The simulator 325 may employ a Fourier transform to calculate the light intensities, for example. Further, the simulator 325 may employ a molecular dynamics simulation model to calculate molecular states of the first and the second resist films after the PEB process and a string model to calculate surface states of the first and the second resist films after the development.

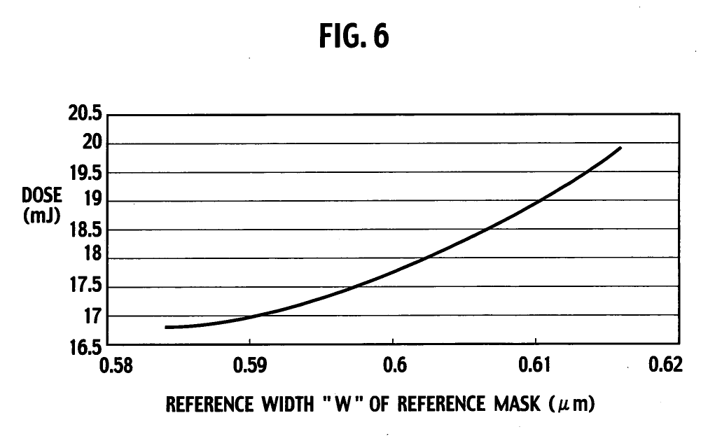

FIG. 6 shows a relationship between the reference width “w” of the first reference mark 20a and a dose required to keep the line width of the resist pattern formed with 4× reduction 150 nm of the product design value. The dose is calculated by the simulator 325. From the graph of FIG. 6, in the case where the first actual width D_{A1} is 605 nm, the first calculated dose “V₁” to keep the line width of the resist pattern 150 nm is 18.39 mJ. In the case where the second actual width D_{A2} is 602 nm, the second calculated dose “V₂” to keep the line width of the resist pattern 150 nm is 18.00 mJ.

Further, the simulator 325 fetches the instrumental error data of the coater 2, the exposure tool 3, the heater 5, and the developing tool 4 from the device information memory module 338 in order to speculate the first calculated dose “V₁” and the second calculated dose “V₂” reflecting the instrumental error data.

The dose calculator 256 calculates a correction coefficient “C” by dividing the second calculated dose “V₂” by the first calculated dose “V₁” as given in equation (1). Also, the dose calculator 256 calculates the second optimum dose “E₂” for the second mask by multiplying the first optimum dose “E₁” by the correction coefficient “C” as given in equation (2). The second optimum dose “E₂” reflects the first actual width “D_{A1}” and the second actual width “D_{A2}”. The dose calculator 256 stores the calculated second optimum dose “E₂” in the second mask data region 51a shown in FIG. 5.
C=V₂/V₁ (1)
E₂=E₁*C (2)

The exposure tool controller 253 shown in FIG. 1 adjusts the dose of the exposure tool 3 to the first optimum dose “E₁” in the case where the first mask shown in FIG. 2 is disposed on the reticle stage 15 in the exposure tool 3. Also, the exposure tool controller 253 shown in FIG. 1 adjusts the dose of the exposure tool 3 to the second optimum dose “E₂” in the case where the second mask is disposed on the reticle stage 15. Further, the exposure tool controller 253 controls the exposure conditions of the exposure tool 3 in compliance with the manufacturing recipe stored in the product information memory module 340. For example, the exposure tool controller 253 instructs the reticle stage aligner 97 shown in FIG. 4 and the wafer stage aligner 94 to shift and tilt the reticle stage 15 and the wafer stage 32. The exposure tool controller 253 also monitors the orientation, the shift direction, and the shift speed of the reticle stage 15 and the wafer stage 32 by using the interferometer 99 and the interferometer 95. The exposure tool controller 253 shown in FIG. 1 stores the set exposure condition in the process information memory module 339 in the case where the exposure tool controller 253 sets the exposure condition that is differ from the exposure condition contained in the manufacturing recipe. In this case, the data manager 400 associates the data of the set exposure condition with the data of the lot number or the identifier of the silicon wafer.

The coater controller 252 controls fluid channels to supply the antireflection materials or the resist solution to the coater 2 from chemicals feeders. Also, the coater controller 252 sets the rotation acceleration, the rotation speed, and the coating time of the coater 2. The heater controller 255 adjusts the heating conditions in the heater 5 in compliance with the manufacturing recipe stored in the product information memory module 340. The developing tool controller 254 adjusts developing conditions of the developing tool 4 in compliance with the manufacturing recipe stored in the product information memory module 340. The thickness tester controller 321 sets measurement conditions of the thickness tester 201. Also, the thickness tester controller 321 stores each actual thickness of the antireflection coating, the first resist film, and the second resist film measured by the thickness tester 201 in the process information memory module 339. In this case, the data manager 400 associates the data of the actual thickness with the data of the identifier of the silicon wafer.

The mask data memory module 336 stores a mask database 101 shown in FIG. 5. The mask database 101 contains a first design rule data group 61 and a second design rule data group 62. The first design rule data group 61 contains information on photo masks designed with the design rule of 150 nm. The second design rule data group 62 contains information on photo masks designed with the design rule of 90 nm. For example, the first design rule data group 61 contains a first mask data region 21 storing the first actual width “D_{A1}” of the first reference mark 20a shown in FIG. 3 and information on doses used for the exposure process. Also, the first design rule data group 61 contains the second mask data region 51a storing the second actual width “D_{A2}” of the second reference mark of the second mask. Further, the first design rule data group 61 contains third mask data region 51b and fourth mask data region 51c. The third mask data region 51b stores a third actual width of the reference width “W” of a third mask that is one of the sister products to the first mask. The fourth mask data region 51c stores a fourth actual width of the reference width “W” of a fourth mask that is one of the sister products to the first mask. The second design rule data group 62 contains 21st mask data region 22 storing information on a 21st mask designed with the design rule of 90 nm. Further, the second design rule data group 62 contains 22nd mask data 52a, 23rd mask data 52b, and 24th mask data 52c storing information on a 22nd mask, a 23rd mask, and a 24th mask, respectively. Each of the 22nd mask, the 23rd mask, and the 24th mask is one of the sister products to the first mask.

With reference again to FIG. 1, an input unit 312, an output unit 313, a program memory 330, and a temporary memory 331 are also connected to the CPU 300. A keyboard and a mouse may be used for the input unit 312. An LCD and an LED may be used for the output unit 313. The program memory 330 stores a program instructing the CPU 300 to transfer data with apparatuses connected to the CPU 300. The temporary memory 331 stores a temporary data calculated during operation by the CPU 300.

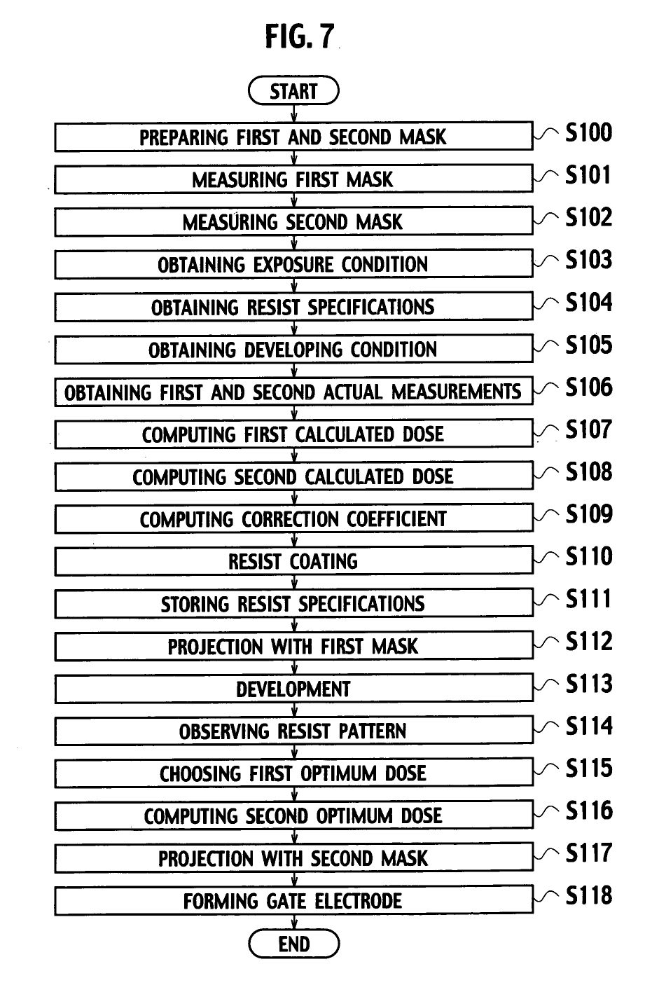

With reference next to FIG. 7, a method for manufacturing the semiconductor device according to the first embodiment of the present invention is described. It should be noted that operation results by the CPU 300 shown in FIG. 1 are successively stored in the temporary memory 331.

In step S100, the first mask shown in FIG. 2 to be used for manufacturing the SRAM is prepared. Also, by making minor changes to the circuit pattern delineated in the device pattern window 57 of the first mask, the second mask that is the sister product to the first mask is prepared. In step S101, the microscope 332 shown in FIG. 1 measures the first actual width “D_{A1}” of the first reference mark 20a of the first mask shown in FIG. 3. Then, the microscope 332 stores the first actual width “D_{A1}” in the first mask data region 21 shown in FIG. 5. For example, the designed width of the reference width “W” of the first mask is 600 nm and the first actual width “D_{A1}” is 605 nm. Thereafter, the data manager 400 shown in FIG. 1 stores the position of the first reference mark 20a in the first mask in the first mask data region 21 shown in FIG. 5. Then, the data manager 400 shown in FIG. 1 associates the data of the first actual width “D_{A1}” with the data of the position of the first reference mark 20a in the first mask data region 21.

In step S102, the microscope 332 shown in FIG. 1 measures the second actual width “D_{A2}” of the second reference mark of the second mask. The designed value of the reference width “W” of the second reference mark is also 600 nm. Then, the microscope 332 stores second actual width “D_{A2}” in the second mask data region 51a shown in FIG. 5. For example, the second actual width “D_{A2}” is 602 nm. Thereafter, the data manager 400 shown in FIG. 1 stores the position of the second reference mark in the second mask in the second mask data region 51a shown in FIG. 5. And the data manager 400 shown in FIG. 1 associates the data of the second actual width “D_{A2}” with the data of the position of the second reference mark in the second mask.

In step S103, the simulator 325 fetches the data of the exposure conditions, such as the polarization state, the NA of the projection optical system 42 shown in FIG. 4, the coherence factor C, and the aperture type for annular or quadrupolar illumination from the product information memory module 340 shown in FIG. 1. To accelerate the simulation accuracy, the simulator 325 fetches the dose error data of the light source 41 shown in FIG. 4, the position error data and the leveling error data of the reticle stage 15 and the wafer stage 32 from the device information memory module 338 shown in FIG. 1. Also, the simulator 325 fetches the accuracy data, the birefringence data, and the aberration data of the telecentric system of the projection optical system 42 shown in FIG. 4 and the unevenness data of the intensity of the light from the device information memory module 338 shown in FIG. 1.

In step S104, the simulator 325 fetches the resist descriptions, such as the reflectance and the refractive index of the antireflection coating, the first resist film, and the second resist film from the process information memory module 339. Also, the simulator 325 fetches the data of the actual thicknesses of the antireflection coating, the first resist film, and the second resist film from the process information memory module 339. In step S105, the simulator 325 fetches the data of the developing conditions, such as the heating condition, the concentration of the developer solution, and the developing time from the product information memory module 340. Also, the simulator 325 fetches the data of the actual measurement of the development rate, the thermometer error data of the heater 5 and the developing tool 4, and the concentration meter error data of the developing tool 4 from the process information memory module 339 and the device information memory module 338.

In step S106, the simulator 325 fetches the data of the first actual width “D_{A1}” and the second actual width “D_{A2}” from the first mask data region 21 and the second mask data region 51a in the mask database 101 shown in FIG. 5. In step S107, the simulator 325 speculates the first calculated dose “V₁” required to form the resist pattern having 150 nm of the line width that is equal to the product design value under the condition where the first reference mark 20a having 605 nm of the reference width “W” that is equal to the first actual width “D_{A1}” is projected onto the first resist film and thereafter the first resist film is baked and developed. Here, the simulator 325 uses the exposure conditions fetched in step S103, the resist descriptions fetched in step S104, and the developing conditions fetched in step S105 to speculate the first calculated dose “V₁”. For example, when the first reference mark 20a has 605 nm of the reference width “W”, the first calculated dose “V₁” speculated by the simulator 325 is 18.39 mJ as shown in FIG. 6.

In step S108, the simulator 325 shown in FIG. 1 speculates the second calculated dose “V₂” required to form the resist pattern having 150 nm of the line width under the condition where the second reference mark having 602 nm of the reference width “W” that is equal to the second actual width “D_{A2}” is projected onto the second resist film and thereafter the second resist film is baked and developed. Here, the simulator 325 uses the exposure conditions fetched in step S103, the resist descriptions fetched in step S104, and the developing conditions fetched in step S105 to speculate the second calculated dose “V₂”. For example, when the second reference mark has 602 nm of the reference width “W”, the second calculated dose “V₂” speculated by the simulator 325 is 18.00 mJ as shown in FIG. 6. In step S109, the dose calculator 256 assigns the second calculated dose “V₂” to the variable “V₂” in the equation (1). Also, the dose calculator 256 assigns the first calculated dose “V₁” to the variable “V₁” in the equation (1). Thereafter, the dose calculator 256 calculates the correction coefficient “C” by using the equation (1).

In step S110, the silicon wafers covered with gate oxides and polycrystalline silicon layers are prepared. Then, the coater 2 coats each of the silicon wafers with the antireflection coating of which the designed thickness is 60 nm in compliance with the coater conditions including the rotation speed, the temperature, and the volume of the antireflection solution stored in the product information memory module 340. Further, the coater 2 coats the antireflection coating with the first resist film of which the designed thickness is 300 nm in compliance with the coater conditions stored in the product information memory module 340. Also, the coater 2 coats the antireflection coating with the second resist film of which the designed thickness is 300 nm. In step S111, the thickness tester 201 measures each actual thickness of the antireflection coating, the first resist film, and the second resist film. The thickness tester 201 stores the actual thickness in the process information memory module 339. Thereafter, the data manager 400 associates the data of the actual thickness with the data of the identifier of the silicon wafer in the process information memory module 339.

In step S112, the first mask shown in FIG. 2 is disposed on the reticle stage 15 of the exposure tool 3 shown in FIG. 4. Also, the silicon wafer covered with the first resist film is disposed on the wafer stage 32. Then, the exposure tool controller 253 sets the exposure conditions of the exposure tool 3 in compliance with the manufacturing recipe stored in the product information memory module 340. For example, the exposure tool controller 253 sets the light wavelength, the numerical aperture (NA), the coherence factor a of the peripheral region of the annular illumination, and the coherence factor a of the central region of the annular illumination to 193 nm, 0.63, 0.75, and 0.5, respectively. Thereafter, with a 4× reduction ratio, the first reference mark 20a of the first mask shown in FIG. 3 is projected onto a plurality of exposure fields on the first resist film at the plurality of doses, respectively. The exposure tool controller 253 stores the plurality of doses in the process information memory module 339. Thereafter, the data manager 400 associates the data of the doses with the data of the identifier of the silicon wafer in the process information memory module 339.

In step S113, the heater 5 bakes the exposed first resist film in compliance with the heating conditions contained in the manufacturing recipe stored in the product information memory module 340. The developing tool 4 develops the first resist film to form the test resist patterns in compliance with the developing conditions contained in the manufacturing recipe stored in the product information memory module 340. While the developing tool 4 develops the first resist film, the developing tool 4 measures the actual development rate by the internal development rate meter (DRM) The developing tool 4 stores the actual development rate in the process information memory module 339.

In step S114, the microscope 332 measures the actual measurements of the line widths of the test resist patterns. Then, the microscope 332 stores the actual measurements of the line widths of the test resist patterns in the process information memory module 339. Thereafter, the data manager associates the data of the actual measurements of the line widths of the test resist patterns with the identifier of the silicon wafer in the process information memory module 339. In step S115, the choose module 324 chooses the “optimum resist pattern” having the actual measurement of the line width that is nearest to 150 nm of the product design value and stores the “optimum resist pattern” in the process information memory module 339. Thereafter, the choose module 324 fetches the data of the dose that is used for forming the “optimum resist pattern” from the process information memory module 339. The choose module 324 defines the dose that is used for forming the optimum resist pattern as the first optimum dose “E₁”. The choose module 324 stores 17.5 mJ as an example of the first optimum dose “E₁” in the first mask data region 21 in the mask database 101 shown in FIG. 5.

In step S116, the dose calculator 256 calculates the second optimum dose “E₂” by multiplying the first optimum dose “E₁” by the correction coefficient “C” as shown in equation (2). In the case where the first optimum dose “E₁”, the second optimum dose “V₂”, and the first calculated dose “V₁” are 17.5 mJ, 18.0 mJ, and 18.39 mJ, respectively, the second optimum dose “E₂” is 17.13 mJ. The dose calculator 256 stores the second optimum dose “E₂” in the second mask data region 51a in the mask database 101.

In step S117, the second mask is disposed on the reticle stage 15 of the exposure tool 3 shown in FIG. 4. Also, the silicon wafer coated with the second resist film is disposed on the wafer stage 32. The exposure tool controller 253 shown in FIG. 1 sets the dose of the light emitted from the light source 41 to the second optimum dose “E₂”. Thereafter, the exposure tool 3 projects the mask patterns of the second mask onto the second resist film at the second optimum dose “E₂”. Next, the heater 5 bakes the second resist film and the developing tool 4 develops the second resist film in compliance with the manufacturing recipe stored in the product information memory module 340. Consequently, the projected pattern of the second reference mark of which the line width is near to 150 nm of the product design value is formed in the second resist film.

In step S118, an anisotropic etch process is employed to selectively remove the polycrystalline silicon layer using the second resist pattern as an etch mask. By the anisotropic etch process, the gate electrode is formed on the silicon wafer. Thereafter, the silicon wafer is selectively doped with dopants and the annealing process is employed to activate the doped dopants and diffuse the doped dopants in the silicon wafer. Consequently, source and drain regions are formed in the silicon wafer. Thereafter, multi-level interconnects are formed on the silicon wafer and the semiconductor device is obtained.

In a shop floor of the semiconductor industry, when the first mask is damaged, the first mask should be replaced with the second mask belonging to the same lot. In the meantime, when the minor change to the semiconductor device is made, the first mask should be replaced with the second mask belonging to the different lot. Though the first mask is replaced with the second mask, the exposure system and the method shown in FIGS. 1 and 7 make it possible to reproduce the same resist patterns by employing the second optimum dose “E₂”.

In earlier methods, an optimum dose for the second mask has been experimentally optimized as the first optimum dose “E₁” for the firs mask is optimized from step S110 to step S115 to keep the line widths of the resist patterns. Therefore, it has been impossible to use the exposure tool 3 for manufacturing the semiconductor devices during the optimization of the dose for the second mask. Accordingly, such methods have reduced the availability factor of the exposure tool 3. However, the exposure system and the method shown in FIGS. 1 and 7 employ the simulator 325 and the dose calculator 256 to calculate the second optimum dose “E₂”. Therefore, the exposure tool 3 still continue to manufacture the semiconductor devices during the calculation of the second optimum dose “E₂”. Consequently, the availability factor of the exposure tool 3 is improved. Further, the second optimum dose “E₂” is calculated based on the first actual width D_{A1}, the second actual width D_{A2}, and the first optimum dose “E₁” in steps S115 and S116. The first calculated dose “V₁” and the second calculated dose “V₂” might contain the simulation errors. However, the second optimum dose “E₂” is calculated by dividing the second calculated dose “V₂” by the first calculated dose “V₁”. Such calculation reduces the simulation errors. Consequently, the resist pattern having the line width near to the product design value is obtained by employing the second optimum dose “E₂”.

Here, the first mask is replaced with the second mask in the method for manufacturing the semiconductor device as an example. However, the first mask can be replaced with the third mask or the fourth mask manufactured with the same design rule and of which the specifications are stored in the mask database 101 shown in FIG. 5. Similarly, the second mask can be replaced with the third mask or the fourth mask. In such case, the exposure system according to the first embodiment provides the optimum dose for the replaced mask.

In step S101 and step S102, measuring the first actual width D_{A1} and the second actual width D_{A2} by a photo mask manufacturer is an alternative. In such case, the first actual width D_{A1} and the second actual width D_{A2} are stored in the mask data memory module 336 by using the input unit 312.

An order of carrying out steps of the method for manufacturing the semiconductor device shown in FIG. 7 is changeable. For example, steps 109-115 may be carried out to calculate the first optimum dose “E₁” before steps S103-S108 are carried out to speculate the first and the second calculated doses “V₁”, “V₂”. In this case, the simulator 325 may fetch the actual thicknesses of the antireflection coating and the first resist film and the actual development rate of the first resist film measured in step S111 and step S113 to improve calculation accuracies of the first and the second doses “V₁”, “V₂”.

### First Modification

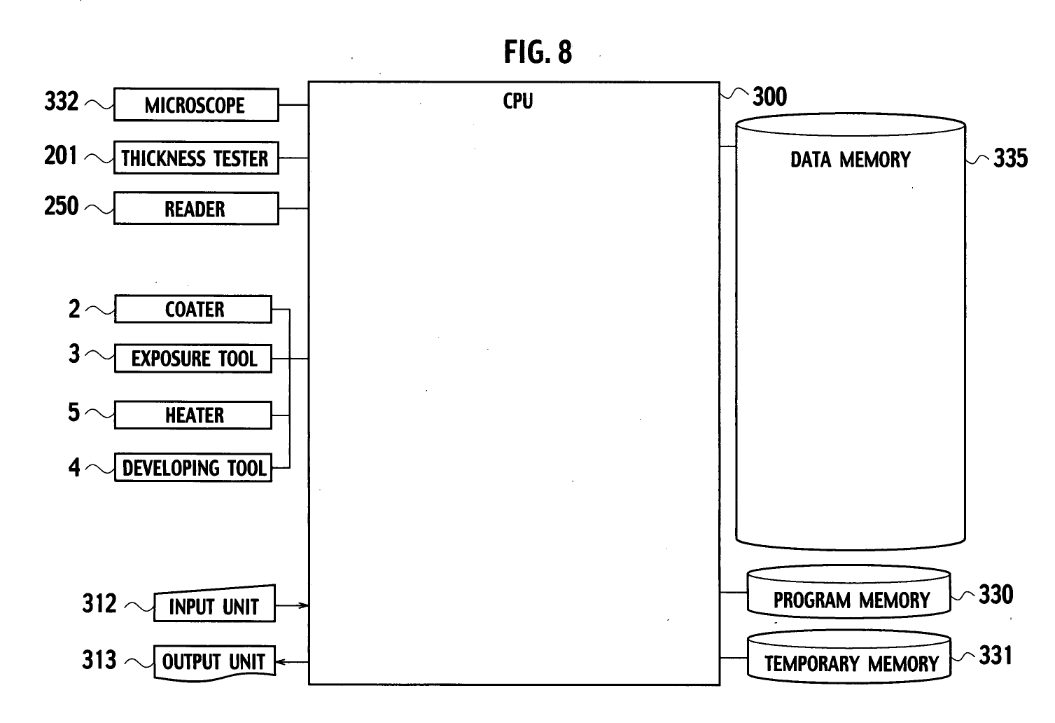

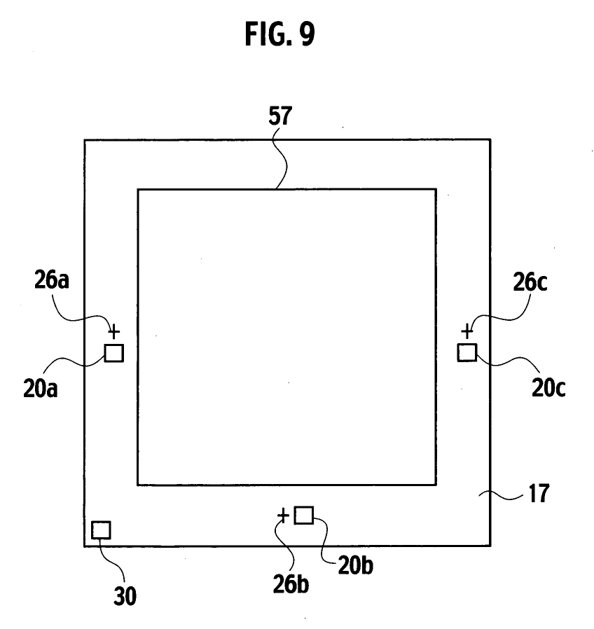

With reference to FIG. 8, the exposure system according to the first modification of the first embodiment further includes a reader 250 connected to the CPU 300. The reader 250 reads information stored in an identifier module 30 disposed on the light shielding film 17 of the first mask shown in FIG. 9. The bar code and the IC tag can be used for the identifier module 30. The identifier module 30 stores the information containing the design rule for the first mask and the first actual width “D_{A1}” of the reference width “W” shown in FIG. 3, for example. The second mask according to the first modification also includes the identifier module storing the design rule for the second mask and the second actual width “D_{A2}” of the reference width “W”. Other components of the exposure system shown in FIG. 8 are similar to components of the exposure system shown in FIG. 1.

When the exposure system shown in FIG. 8 is employed for the method show in FIG. 7, the first actual width “D_{A1}” and the second actual width “D_{A2}” measured in step S101 and step S102 are stored in the identifier module 30 of the first mask shown in FIG. 9 and the identifier module of the second mask, respectively. In step S106, the first actual width “D_{A1}” and the second actual width “D_{A2}” stored in the identifier module 30 of the first mask and the identifier module of the second mask are read by the reader 250. Other steps of the method for manufacturing the semiconductor device according to the first modification of the first embodiment are similar to steps of the method according to the first embodiment.

### Second Modification

In the first embodiment, the correction coefficient “C” is calculated by dividing the second calculated dose “V₂” by the first calculated dose “V₁” in steps S107 and S108 of FIG. 7. In a second modification of the first embodiment, the simulator 325 shown in FIG. 1 speculates a first optical intensity “I₁” of the light through the first mask in the case where the light source 41 shown in FIG. 4 emits the first optimum dose “E₁” of the light. Also, the simulator 325 shown in FIG. 1 speculates a second optical intensity “I₂” of the light through the second mask in the case where the light source 41 shown in FIG. 4 emits the first optimum dose “E₁” of the light. Here, the dose calculator 256 calculates the correction coefficient “C” by dividing the second optical intensity “I₂” by the first optical intensity “I₁”.

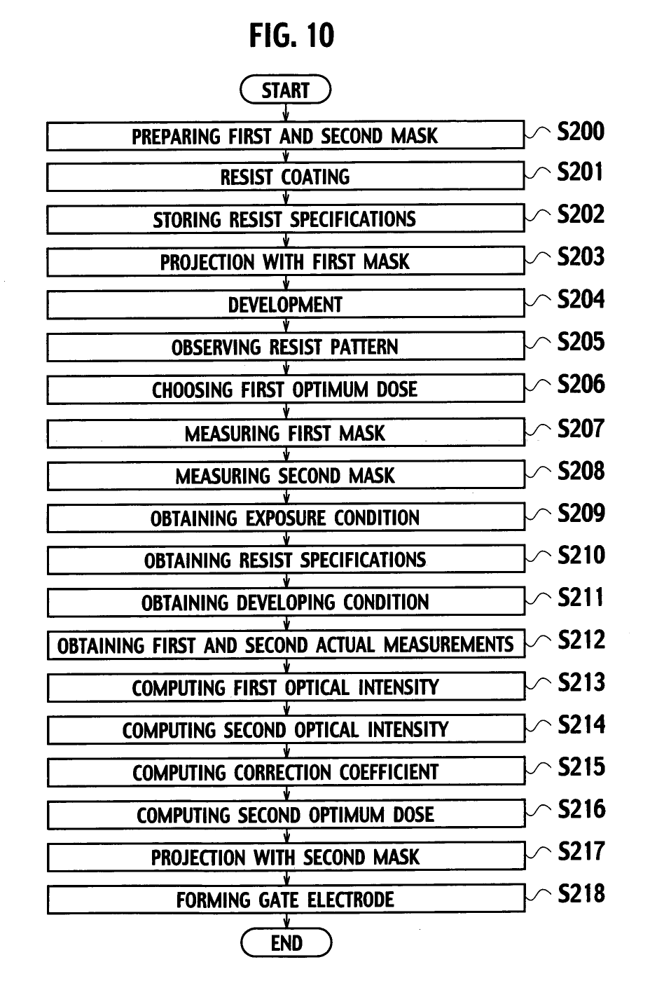

With reference to FIG. 10, a method for manufacturing the semiconductor device according to the second modification of the first embodiment of the present invention is described.

Step S200 is carried out as similar to step S100-S106 shown in FIG. 7. Then, steps S201-S206 of FIG. 10 are carried out as similar to steps S110-S115 shown in FIG. 7. Thereafter, steps S207-S212 of FIG. 10 are carried out as similar to steps S101-S106 shown in FIG. 7.

In step S213 of FIG. 10, the simulator 325 speculates the first optical intensity “I₁” of the light through the first reference mark 20a having the first actual width “D_{A1}” in the case where the light source 41 shown in FIG. 4 emits the light at the first optimum dose “E₁”.

In step S214, the simulator 325 speculates the second optical intensity “I₂” of the light through the second reference mark having the second actual width “D_{A2}” in the case where the light source 41 shown in FIG. 4 emits the light at the first optimum dose “E₁”.

In step S215, the dose calculator 256 assigns the second optical intensity “I₂” to the variable “V₂” in the equation (1). Also, the dose calculator 256 assigns the first optical intensity “I₁” to the variable “V₁” in the equation (1). Thereafter, the dose calculator 256 calculates the correction coefficient “C” by using the equation (1).

In step S216 shown in FIG. 10, the dose calculator 256 calculates the second optimum dose “E₂” by multiplying the first optimum dose “E₁” by the correction coefficient “C” as shown in equation (2). Thereafter, step S217 is carried out as similar to step S117 shown in FIG. 7 to project the patterns of the second mask onto the second resist film at the second optimum dose “E₂”. In step S218, the semiconductor device is obtained.

The method in accordance with the second modification of the first embodiment also makes it possible to maintain pattern fidelity though the first mask is replaced with the second mask.

### Second Embodiment

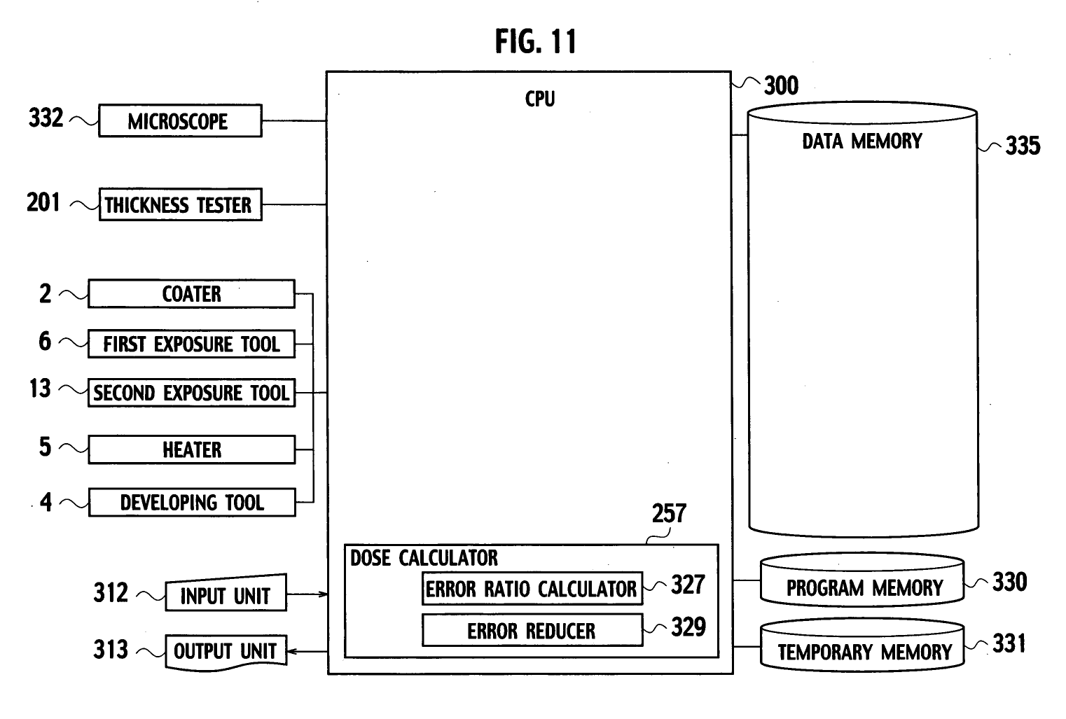

With reference to FIG. 11, the exposure system according to a second embodiment includes a first exposure tool 6 and a second exposure tool 13 connected to the CPU. Further, the dose calculator 257 includes an error ratio calculator 327 and an error reducer 329. Other components of the exposure system shown in FIG. 11 are similar to components of the exposure system shown in FIG. 1. Each structure of the first and the second exposure tools 6 and 13 is similar to a structure of the exposure tool 3 shown in FIG. 4. The instrumental error data of the first and the second exposure tools 6 and 13 are stored in the device information memory module 338.

The error ratio calculator 327 fetches the dose error data of the first exposure tool 6 from the device information memory module 338 to calculate a first actual dose “S₁” corresponding to a set dose of the first exposure tool 6 set by the exposure tool controller 253. Also, the error ratio calculator 327 fetches the dose error data of the second exposure tool 13 from the device information memory module 338 to calculate a second actual dose “S₂” corresponding to a set dose of the second exposure tool 13 set by the exposure tool controller 253. Further, the error ratio calculator 327 calculates an error ratio “A” by dividing the second actual dose “S₂” by the first actual dose “S₁” as given in equation (3).
A=S₂/S₁ (3)

The error reducer 329 calculates the correction coefficient “C” given by the equation (1) and calculates the second optimum dose “E₂” by multiplying the first optimum dose “E₁” by the correction coefficient “C” and the error ratio “A” as given in equation (4).
E₂=E₁*C*A (4)

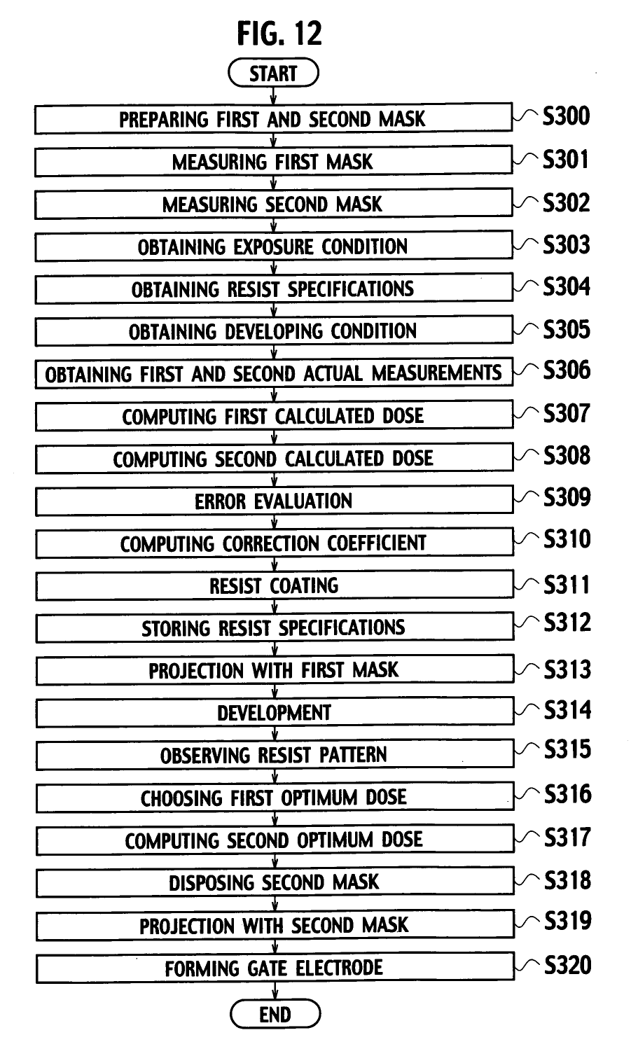

With reference next to FIG. 12, the method for manufacturing the semiconductor device according to the second embodiment of the present invention is described. It should be noted that operation results by the CPU 300 shown in FIG. 11 are successively stored in the temporary memory 331.

Step S300 to step S308 are carried out similarly to the processes of step S100 to step S108 shown in FIG. 7. In step S309 of FIG. 12, the error ratio calculator 327 fetches the dose error data of the first exposure tool 6 from the device information memory module 338 to calculate the first actual dose “S₁” corresponding to the set dose of the first exposure tool 6 set by the exposure tool controller 253. Also, the error ratio calculator 327 fetches the dose error data of the second exposure tool 13 from the device information memory module 338 to calculate the second actual dose “S₂” corresponding to the set dose of the second exposure tool 13 set by the exposure tool controller 253. Thereafter, the error ratio calculator 327 calculates the error ratio “A” given by the equation (3). For example, the error ratio “A” is 0.95.

In step S310, the error reducer 329 assigns the first calculated dose “V₁” and the second calculated dose “V₂” to the variable “V₁” and the variable “V₂” in the equation (1), respectively. Then, the error reducer 329 calculates the correction coefficient “C”. Thereafter, step S311 to step S318 are carried out similarly to the processes of step S110 to step S115 shown in FIG. 7. Instep S317, the error reducer 329 calculates the second optimum dose “E₂” by multiplying the first optimum dose “E₁” by the correction coefficient “C” and the error ratio “A”. In the case where the first optimum dose “E₁”, the second calculated dose “V₂”, the first calculated dose “V₁” and the error ratio “A” are 17.5 mJ, 18.00 mJ, 18.39 mJ, and 0.95, respectively, the second optimum dose “E₂” is 16.27 mJ.

In step S318, the second mask is disposed on the reticle stage of the second exposure tool 13. In step S319, the mask pattern of the second mask is projected onto the second resist film coated on the silicon wafer disposed on the second exposure tool 13 at the second optimum dose “E₂”. Thereafter, the heater 5 bakes the second resist film and the developing tool 4 develops the baked second resist film in compliance with the manufacturing recipe stored in the product information memory module 340. Consequently, the resist pattern of which the line width is near to the product design value is formed in the second resist film. Then, step S320 is carried out similar to step S118 shown in FIG. 7 and the semiconductor device is obtained.

As described above, in the second embodiment, the first mask is replaced with the second mask. Further, the first exposure tool 6 is exchanged for the second exposure tool 13. However, by projecting the mask pattern of the second mask onto the second resist film in the second exposure tool 13 at the second optimum dose “E₁” reflecting the correction coefficient “C” and the error ratio “A”, it is possible to maintain the pattern fidelity.

### Third Embodiment

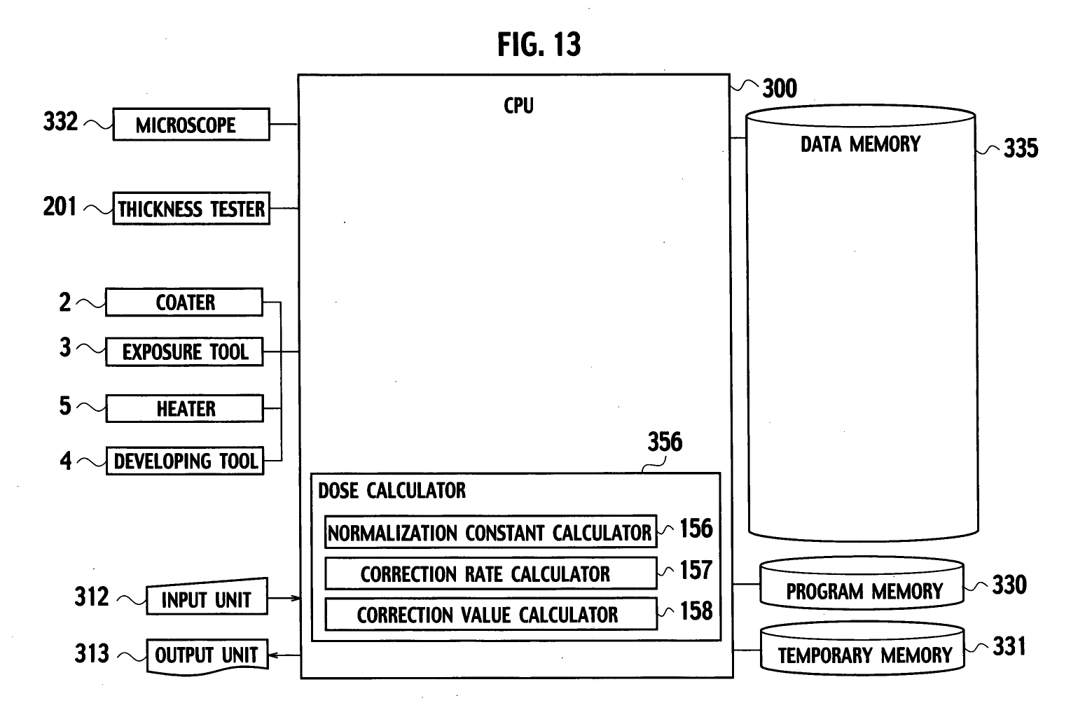

With reference to FIG. 13, the dose calculator 356 of the exposure system according to a third embodiment of the present invention includes a normalization constant calculator 156, a correction rate calculator 157, and a correction value calculator 158. The simulator 325 shown in FIG. 13 speculates the first calculated dose “V₁” required to project the first reference mark 20a having a first biased width onto the first resist film to form the resist pattern having the line width that is equal to the product design value. Here, the first biased width is a sum of the designed width of the first reference mark and a first bias. It should be noted that the first bias could be zero. The simulator 325 also speculates the second calculated dose “V₂” required to project the second reference mark having a second biased width onto the second resist film to form the resist pattern having the line width that is equal to the product design value. Here, the second biased width is a sum of the designed width of the second reference mark and a second bias. Here, a bias difference “ΔLₘ” between the second bias and the first bias is defined. In the case where the first bias is zero, the bias difference “ΔLₘ” is equal to the second bias.

The normalization constant calculator 156 calculates a dose change “ΔE” that is difference between the first calculated dose “V₁” and the second calculated dose “V₂”. Further, the normalization constant calculator 156 calculates a proportional constant “R” by dividing the dose change “ΔE” by the bias difference “ΔLₘ” as given in the equation (5). Also, the normalization constant calculator 156 calculates a normalization constant “N” by dividing the proportional constant “R” by the first calculated dose “V₁” as given in the equation (6).
R=(V₁−V₂)/ΔLₘ (5)
N=R/V₁ (6)

The correction rate calculator 157 calculates a correction rate “F” by multiplying an actual width change that is a difference between the first actual width “D_{A1}” and the first actual width “D_{A2}” by the normalization constant “N” as given in equation (7)
F=(D_{A1}−D_{A2})*N (7)

The correction value calculator 158 calculates a correction bias “ΔEₐ” by multiplying the first optimum dose “E₁” and the correction rate “F” as given in equation (8). Further, the correction value calculator 158 calculates the second optimum dose “E₂” by subtracting the correction bias “ΔEₐ” from the first optimum dose “E₁” as given in equation (9).
ΔEₐ=E₁*F (8)
E₂=E₁ΔEₐ (9)

Other components of the exposure system shown in FIG. 13 are similar to components of the exposure system shown in FIG. 1.

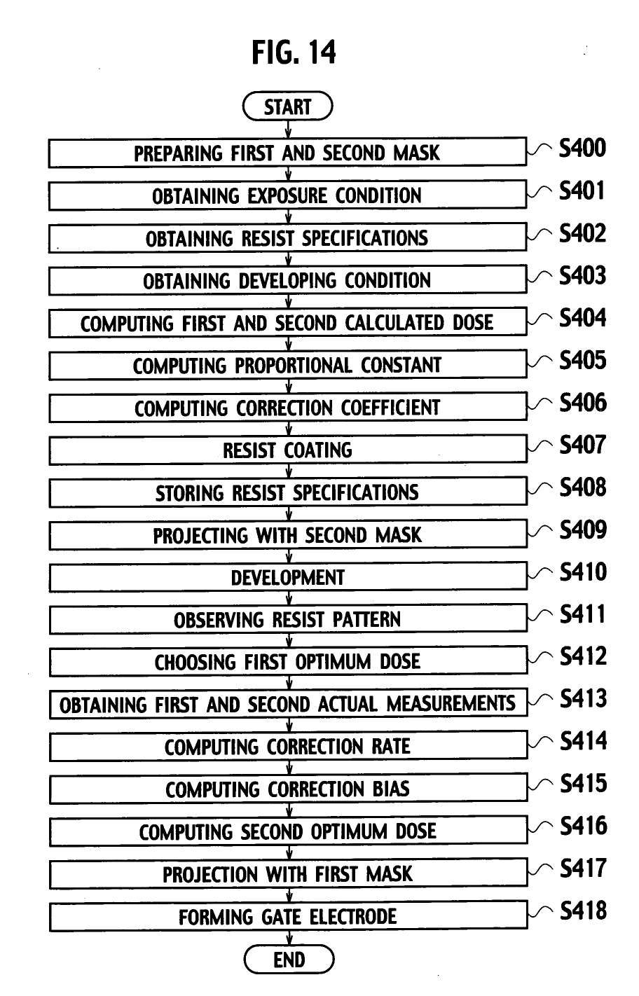

With reference next to FIG. 14, the exposure method according to the third embodiment of the present invention is described. It should be noted that operation results by the CPU 300 shown in FIG. 13 are successively stored in the temporary memory 331.

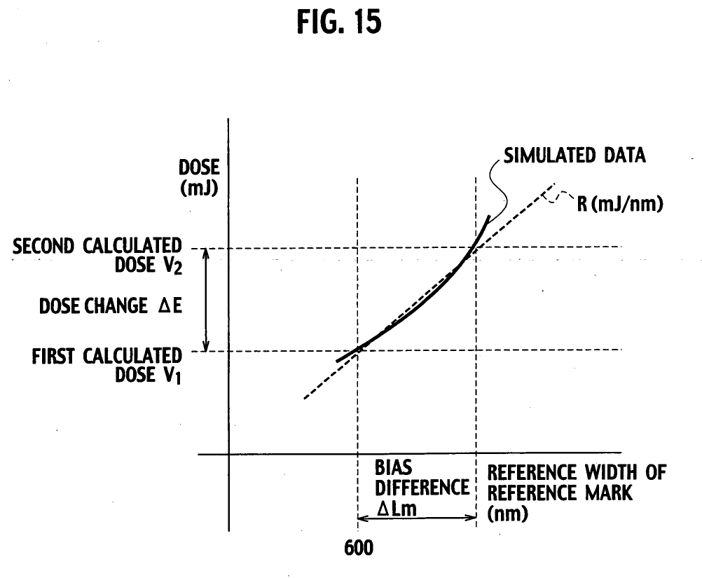

In step S400, the first and the second masks are manufactured. Thereafter, steps S401-S403 are carried out as similar to steps S103-S105 shown in FIG. 7 and the simulator 325 fetches the data of the exposure conditions in the exposure tool 3, the resist descriptions, the developing conditions, and the like from the data memory 335. In step S404 of FIG. 14, the simulator 325 shown in FIG. 13 speculates the first calculated dose “V₁” required to project the first reference mark 20a onto the first resist film to form the resist pattern having 150 nm of the line width based on the first biased width. For example, the first bias is zero and the first biased width is 600 nm. Then, the simulator 325 speculates the second calculated dose “V₂” required to project the second reference mark onto the second resist film to form the resist pattern having 150 nm of the line width based on the second biased width as shown in FIG. 15. Since the first bias is zero, the bias difference “ΔLₘ” is equal to the second bias.

In step S405, the normalization constant calculator 156 shown in FIG. 13 calculates the dose change “ΔE” (mJ) that is difference between the first calculated dose “V₁” and the second calculated dose “V₂” shown in FIG. 15. Then, the normalization constant calculator 156 calculates the proportional constant “R” (mJ/nm) by dividing the dose change “ΔE” (mJ) by the bias difference “ΔLₘ” (nm) as given in the equation (5). In step S406, the normalization constant calculator 156 calculates the normalization constant “N” (1/nm) by dividing the proportional constant “R” (mJ/nm) by the first calculated dose “V₁” (mJ) as given in the equation (6). For example, the calculated normalization constant “N” (1/nm) is 0.3*10⁻² (1/nm).

Steps S407-S412 are carried out as similar to steps S110-S115 shown in FIG. 7 and the choose module 324 defines the dose that is used for forming the optimum resist pattern as the first optimum dose “E₁”. The choose module 324 stores 18.39 mJ as an example of the first optimum dose “E₁” in the first mask data region 21 in the mask database 101 shown in FIG. 5. Instep S413 of FIG. 14, the correction rate calculator 157 fetches the data of the first actual width “D_{A1}” and the second actual width “D_{A2}” from the first mask data region 21 and the second mask data region 51a in the mask database 101 shown in FIG. 5. For example, the first actual width “D_{A1}” is 605 nm and the second actual width “D_{A2}” is 602 nm.

In step 414 of FIG. 14, the correction rate calculator 157 shown in FIG. 13 calculates the correction rate “F” by multiplying the actual width change that is the difference between the first actual width “D_{A1}” and the first actual width “D_{A2}” by the normalization constant “N” (1/nm) as given in the equation (7). When the first actual width “D_{A1}”, the first actual width “D_{A2}”, and the normalization constant “N” are 605 nm, 602 nm, and 0.3 *10⁻² (1/nm), respectively, the correction rate “F” is 3.9*10⁻². In step S415, the correction value calculator 158 calculates the correction bias “ΔEₐ” (mJ) by multiplying the first optimum dose “E₁” (mJ) and the correction rate “F” as given in the equation (8). When the first optimum dose “E₁” and the correction rate “F” are 18.39 mJ and 3.9*10⁻², respectively, the correction bias “ΔEₐ” is 0.72 mJ.

In step S416, the correction value calculator 158 calculates the second optimum dose “E₂” (mJ) by subtracting the correction bias “ΔEₐ” (mJ) from the first optimum dose “E₁” (mJ) as given in the equation (9). When the first optimum dose “E₁” and the correction bias “ΔEₐ” are 18.39 mJ and 0.72 mJ, respectively, the second optimum dose “E₂” is 17.67 mJ. In step S417, the mask patterns of the second mask onto the second resist film at the second optimum dose “E₂” as step S117 of FIG. 7. Next, the heater 5 bakes the second resist film and the developing tool 4 develops the second resist film in compliance with the manufacturing recipe stored in the product information memory module 340. Thereafter, step S418 is carried out as similar to step S118 shown in FIG. 7 and the semiconductor device is obtained.

As described above, the normalization constant “N” to be employed for calculating the second optimum dose “E₂” is calculated in advance as shown in steps S401-S406 of FIG. 14. Once the normalization constant “N” is obtained, it is possible to eliminate steps S401-S406 in the method. Since the second optimum dose “E₂” calculated by the method according to the third embodiment also reflects the first actual width “D_{A1}” and the second actual width “D_{A2}” obtained in steps S413-S416, it is possible to maintain the pattern fidelity.

### OTHER EMBODIMENTS

Although the invention has been described above by reference to the embodiments of the present invention, the present invention is not limited to the embodiments described above. Modifications and variations of the embodiments described above will occur to those skilled in the art, in the light of the above teachings. For example, the coater 2 shown in FIG. 1, the exposure tool 3, the heater 5, the developing tool 4, the microscope 332, the thickness tester 201, and the CPU300 may be set in distant places. In such case, controlling the coater 2, the exposure tool 3, the heater 5, the developing tool 4, the microscope 332, and the thickness tester 201 by the CPU 300 through the computer network such as the internet is an alternative.

In embodiments described above, the first actual width “D_{A1}” and the second actual width “D_{A2}” are obtained by measuring the first reference mark 20a shown in FIG. 3 and the second reference mark, respectively. The first reference mark 20a is delineated in the light shielding film 17 beside the device pattern window 57. However, using a portion of the circuit pattern in the device pattern window 57 as the first reference mark is an alternative. In such case, a portion of the circuit pattern delineated in the second mask is also used as the second reference mark. Even if the optical proximity correction (OPC) is applied to the circuit pattern, the methods according to the embodiments are available. Also, the designed value of the first reference mark 20a is not of course limited to 600 nm and the methods according to the embodiments are available for various photo masks designed in compliance with various design rules.

As described above, the present invention includes many variations of embodiments. Therefore, the scope of the invention is defined with reference to the following claims.

What is claimed is:

1. An exposure system, comprising:
a simulator configured to speculate a first calculated dose required to project a first reference mark of a first mask onto a first resist film based on a first biased width and a second calculated dose required to project a second reference mark of a second mask onto a second resist film based on a second biased width, the first and the second masks being equivalent in a design rule, the first and the second reference marks having a same designed width, the first biased width being a sum of the designed width and a first bias, the second biased width being a sum of the designed width and a second bias;
an exposure tool configured to project the first reference mark onto the first resist film at a plurality of test doses to form a plurality of test resist patterns in the first resist film;
a choose module configured to choose an optimum resist pattern among the test resist patterns and to choose a first optimum dose used for forming the optimum resist pattern among the test doses; and
a dose calculator configured to calculate a second optimum dose for the second mask by correcting the first optimum dose based on the first and the second calculated doses.

2. The system of claim 1, wherein the first biased width is equal to a first actual width of the first reference mark and second biased width is equal to a second actual width of the second reference mark.

3. The system of claim 1, wherein the dose calculator calculates a correction coefficient by dividing the second calculated dose by the first calculated dose.

4. The system of claim 3, wherein the dose calculator multiplies the first optimum dose by the correction coefficient.

5. The system of claim 1, wherein the dose calculator calculates a proportional constant by dividing a dose change by a bias difference, the dose change being a difference between the first calculated dose and the second calculated dose, the bias difference being a difference between the second bias and the first bias.

6. The system of claim 5, wherein the dose calculator calculates a normalization constant by dividing the proportional constant by the first calculated dose.

7. The system of claim 6, wherein the dose calculator calculates a correction rate by multiplying an actual width change by the normalization constant, the actual width change being a difference between a second actual width of the second reference mark and a first actual width of the first reference mark.

8. The system of claim 7, wherein the dose calculator multiplies the first optimum dose by the correction rate.

9. A method for manufacturing a semiconductor device, comprising:
preparing a first mask having a first reference mark and a second mask having a second reference mark, the first and the second masks being equivalent in a design rule, the first and the second reference marks having the same designed width;
speculating a first calculated dose required to project the first reference mark onto a first resist film based on a first biased width that is a sum of the designed width and a first bias;
speculating a second calculated dose required to project the second reference mark onto a second resist film based on a second biased width that is a sum of the designed width and a second bias;
projecting the first reference mark onto the first resist film at a plurality of test doses to form a plurality of test resist patterns in the first resist film;
choosing an optimum resist pattern among the test resist patterns;
choosing a first optimum dose used for forming the optimum resist pattern among the test doses;
calculating a second optimum dose by correcting the first optimum dose based on the first and the second calculated doses; and
projecting a mask pattern of the second mask onto the second resist film coated on a silicon wafer at the second optimum dose to form a circuit pattern on the silicon wafer.

10. The method of claim 9, wherein the first biased width is equal to a first actual width of the first reference mark and the second biased width is equal to a second actual width of the second reference mark.

11. The method of claim 9, wherein calculating the second optimum dose further comprises calculating a correction coefficient by dividing the second calculated dose by the first calculated dose.

12. The method of claim 11, wherein calculating the second optimum dose further comprises multiplying the first optimum dose by the correction coefficient.

13. The method of claim 9, wherein calculating the second optimum dose further comprises calculating a dose change that is a difference between the first calculated dose and the second calculated dose.

14. The method of claim 13, wherein calculating the second optimum dose further comprises calculating a bias difference that is a difference between the second bias and the first bias.

15. The method of claim 14, wherein calculating the second optimum dose further comprises calculating a proportional constant by dividing the dose change by the bias difference.

16. The method of claim 15, wherein calculating the second optimum dose further comprises calculating a normalization constant by dividing the proportional constant by the first calculated dose.

17. The method of claim 16, wherein calculating the second optimum dose further comprises calculating an actual width change that is a difference between a second actual width of the second reference mark and a first actual width of the first reference mark.

18. The method of claim 17, wherein calculating the second optimum dose further comprises calcualting a correction rate by multiplying the actual width change by the normalization constant.

19. The method of claim 18, wherein calculating the second optimum dose further comprises calculating a correction bias by multiplying the first optimum dose by the correction rate.

20. The method of claim 19, wherein calculating the second optimum dose further comprises subtracting the correction bias from the first optimum dose.
